(19) United States
(12) Patent Application Publication
(10) Pub. No.: US 2026/0164114 A1
(43) Pub. Date: Jun. 11, 2026

(54) VIDEO PROCESSING METHOD, SHOOTING METHOD, IMAGE PROCESS APPARATUS, IMAGING APPARATUS, STORAGE MEDIUM AND COMPUTER PROGRAM PRODUCT

(71) Applicant: ARASHI VISION INC., Shenzhen (CN)

(72) Inventors: Junrong ZHU, Shenzhen (CN); Jingyan HE, Shenzhen (CN)

(73) Assignee: ARASHI VISION INC., Shenzhen (CN)

(21) Appl. No.: 19/178,828

(22) Filed: Apr. 14, 2025

(30) Foreign Application Priority Data
Apr. 16, 2024 (CN) 202410458929.2

(51) Int. Cl. H04N 21/81

(52) U.S. Cl. CPC H04N 23/631

(57) ABSTRACT

The present disclosure provides a video processing method, a shooting method, an image processing device, an imaging apparatus, a storage medium, and a computer program product. In some implementations, the video processing method may include: adjusting an expected video picture of a video to be processed in response to detecting an operation of a joystick; and generating a target video according to the expected video picture. The picture of the target video corresponds to the expected video picture. The target video can be saved.

### CROSS-REFERENCE TO RELATED APPLICATION

The present disclosure claims the benefit of priority to Chinese Patent Application No. 202410458929.2, filed on Apr. 16, 2024, the entire content of which is hereby incorporated by reference in its entirety.

### BACKGROUND

The present disclosure relates to the technical field of image processing, and more particularly to a video processing method, a shooting method, an image processing device, an imaging apparatus, a storage medium, and a computer program product.

Panoramic cameras allow users to shoot first and frame later. During shooting, the focus is on real-time creation without considering framing issues. During post-editing, users can freely select the desired angle, edit clips, and export flat videos.

In related technologies, after entering the free recording mode, the view angle is adjusted by sliding the screen or by rotating the phone through somatosensory interaction to adjust the desired picture into the viewfinder for framing.

The present disclosure at least changes the framing method during video processing.

### SUMMARY

The present disclosure provides a video processing method, a shooting method, an image processing device, an imaging apparatus, a storage medium, and a computer program product, which at least changes the framing method during video processing.

The technical solution of the implementation of The present disclosure is implemented as follows.

An implementation of The present disclosure provides a video processing method, which includes:
adjusting the expected video picture of the video to be processed in response to detecting an operation of a joystick;
generating a target video according to the expected video picture, where the picture of the target video corresponds to the expected video picture; and
saving the target video.

The above solution further includes:
displaying the adjusted expected video picture.

In the above solution, after detecting an operation of the joystick, the method further includes at least one of the following:
if a sliding operation on a touch screen is detected, making no response to the sliding operation; and
if a somatosensory interaction operation is detected, making no response to the somatosensory interaction operation.

In the above solution, adjusting the expected video picture of the video to be processed in response to detecting an operation of a joystick includes:
adjusting the expected video picture of the video to be processed by adjusting the speed of angle rotation corresponding to a gear according to a parameter generated based on the movement of the joystick displayed on the touch screen, where there is a one-to-one relationship between the gear and the range to which the parameter belongs.

In the above solution, adjusting the expected video picture of the video to be processed in response to detecting an operation of a joystick includes:
adjusting the expected video picture of the video to be processed according to the movement direction of the joystick displayed on the touch screen; and
in response to detecting a trigger operation of a preset view angle, moving the joystick to an initial position on the touch screen, and adjusting the expected video picture of the video to be processed according to the preset view angle.

In the above solution, the method further includes:
in response to detecting an operation of a view angle icon of a preset view angle displayed on the touch screen, adjusting the expected video picture of the video to be processed according to the preset view angle, where the preset view angle includes one of a protagonist view angle, a forward view angle, or a panoramic view angle.

In the above solution, the method further includes:
obtaining parameter information saved during shooting of the video to be processed or after shooting of the video to be processed, where the parameter information includes path information and/or view angle information, and the parameter information is configured to implement the operation of the preset view angle;
displaying one or more view angle icons of the protagonist view angle, forward view angle, or panoramic view angle on the touch screen according to the parameter information,
where the protagonist view angle is a view angle of one or more objects in a shooting range of an imaging apparatus, or a view angle of one or more objects determined according to the parameter information; the forward view angle is a view angle in a moving direction of the imaging apparatus; and the panoramic view angle is a view angle that rotates 360 degrees along a horizontal direction from a current picture.

In the above solution, the preset view angle is the panoramic view angle, and adjusting the expected video picture of the video to be processed according to the preset view angle in response to detecting an operation of the view angle icon of the preset view angle displayed on the touch screen includes:
adjusting the expected video picture of the video to be processed by rotating the shooting scene of the video to be processed along a horizontal direction according to the panoramic view angle, in response to detecting an operation of the view angle icon of the panoramic view angle; and after the rotation ends, adjusting the expected video picture of the video to be processed according to the target view angle,
where the target view angle is the selected protagonist view angle or forward view angle before the detection of the operation of the view angle icon of the panoramic view angle, or the target view angle is the view angle as selected according to the joystick before the detection of the operation of the view angle icon of the panoramic view angle.

In the above solution, generating the target video according to the expected video picture includes:
if the set duration of the target video is less than or equal to the actual duration of rotating 360 degrees along a horizontal direction, generating the target video according to the expected video picture and the set duration, where the target video includes a video picture corresponding to the expected field of view within the set duration; and
if the set duration of the target video is greater than the actual duration, generating the target video according to the expected video picture and the actual duration, where the target video includes a video picture corresponding to the expected field of view within the actual duration and a supplementary picture within a remaining duration.

In the above solution, at least two video frames corresponding to the supplementary picture are obtained according to the same video frame of the video to be processed, and the content of at least two video frames is different.

In the above solution, adjusting the expected video picture of the video to be processed in response to detecting an operation of a joystick includes:
adjusting the expected video picture of the video to be processed according to a somatosensory change magnitude corresponding to a somatosensory interaction operation; and
if the somatosensory change magnitude corresponding to the somatosensory interaction operation is less than a preset threshold, adjusting the expected video picture of the video to be processed according to the movement direction of the joystick, in response to detecting an operation of the joystick.

In the above solution, adjusting the expected video picture of the video to be processed in response to detecting an operation of a joystick includes:
detecting a somatosensory interaction operation during a process of responding to the detection of the operation of the joystick; and
adjusting the expected video picture of the video to be processed according to a superposition result of a control quantity of the joystick and a control quantity of the somatosensory interaction operation.

In the above solution, during a process of responding to the detection of an operation of the forward view angle, the operation of the joystick is detected; and the expected video picture of the video to be processed is adjusted according to a superposition result of a lever quantity of the joystick and a view angle direction of the forward view angle.

In the above solution, adjusting the expected video picture of the video to be processed in response to detecting an operation of a joystick includes:
detecting a somatosensory interaction operation during a process of responding to the detection of the operation of the joystick;
if a change quantity of the movement of the joystick is greater than a change quantity of a somatosensory change magnitude of the somatosensory interaction operation, in response to the detection of the operation of the joystick, adjusting the expected video picture of the video to be processed by changing a view angle in a direction of the movement of the joystick;
if the change quantity of the movement of the joystick is less than the change quantity of the somatosensory change magnitude of the somatosensory interaction operation, in response to detecting a somatosensory interaction operation, adjusting the expected video picture of the video to be processed by changing the view angle in a direction of the somatosensory interaction operation; and
if the change quantity of the movement of the joystick is equal to the change quantity of the somatosensory change magnitude of the somatosensory interaction operation, adjusting the expected video picture of the video to be processed according to an operation of maintaining the view angle.

In the above solution, adjusting the expected video picture of the video to be processed in response to detecting an operation of a joystick includes:
in response to detecting an operation of a view angle icon of a preset view angle displayed on the touch screen, adjusting the expected video picture of the video to be processed according to the preset view angle; and
in response to detecting an operation of the joystick, interrupting the preset view angle, and adjusting the expected video picture of the video to be processed according to the movement direction of the joystick.

In the above solution, adjusting the expected video picture of the video to be processed in response to detecting an operation of a joystick includes:
in response to detecting an operation of a view angle icon of a preset view angle displayed on the touch screen, adjusting the expected video picture of the video to be processed according to the preset view angle;
in response to detecting an operation of the joystick, adjusting the expected video picture of the video to be processed according to the movement direction of the joystick; and
if the operation of the joystick is cancelled, adjusting the expected video picture of the video to be processed according to the preset view angle.

In the above solution, the method further includes:
in response to detecting a key frame selection operation by a user, determining at least two key frames of the video to be processed; and
in response to detecting an operation of the joystick, adjusting a transition manner between the at least two key frames in the video to be processed according to a lever quantity of the joystick and a transition curve between the at least two key frames.

In the above solution, generating the target video according to the expected video picture includes:
obtaining reference information, where the reference information includes one or more of the following: video specification information of the video to be processed, processing capability information of an image processing device, playback performance selection information input by a user, and video information of the video to be processed;
determining a video generation mode according to the one or more pieces of information in the reference information; and
processing the expected video picture according to the determined video generation mode to generate the target video.

In the above solution, the video generation mode includes one of the following:
when saving in a cache, generating a flat video based on the expected video picture corresponding to a main bitstream of the video to be processed and an operation result of adjusting the expected video picture of the video to be processed;
saving, in a cache, an operation result of adjusting the expected video picture of the video to be processed, and when exporting, generating a flat video based on the expected video picture corresponding to an auxiliary bitstream of the video to be processed and the operation result; and
saving, in a cache, the operation result, and when exporting, generating a flat video based on the expected video picture corresponding to a main bitstream of the video to be processed and the operation result.

In the above solution, the method further includes:
obtaining path information in a first time period, where the path information is related to a control quantity of the joystick in the first time period;
smoothing the path information; and
determining the expected video picture according to the path information.

In the above solution, the method further includes:
smoothing the path information after generating the target video.

In the above solution, the method further includes:
when determining, according to the path information, that the path information is zero motion path information, adjusting the path information in view of the zero motion path information, so that the path information in the first time period represents zero motion.

In the above solution, the method further includes:
pausing the execution of generating the target video, in response to detecting a pause operation input by a user during the process of generating the target video;
if a resume operation input by the user is detected, continuing the execution of generating the target video; and
cancelling the execution of generating the target video, in response to detecting a cancel operation input by the user during the process of generating the target video.

An implementation of the present disclosure provides a shooting method, which includes:
executing the aforementioned video processing method when an imaging apparatus is in a video recording state, where the video to be processed is a video collected by the imaging apparatus in the video recording state.

An implementation of the present disclosure provides a video processing device, including:
a first processing unit, configured to adjust the expected video picture of the video to be processed in response to detecting an operation of a joystick,
where the first processing unit, configured to generate a target video according to the expected video picture, and the picture of the target video corresponds to the expected video picture; and
a first storage unit, configured to save the target video.

An implementation of the present disclosure provides an imaging apparatus, including:
a second processing unit, configured to execute the aforementioned video processing method when an imaging apparatus is in a video recording state, where the video to be processed is a video collected by the imaging apparatus in the video recording state.

An implementation of the present disclosure provides an image processing device, including: a communication component, a first processor, and a first memory.

The communication component is used to communicate with external devices to obtain the video to be processed.

The first memory is used to store a computer program that can be run on the first processor.

The first processor is used to execute the operations of the aforementioned video processing method when running the computer program.

An implementation of the present disclosure provides an imaging apparatus, including: a shooting component, a second processor, and a second memory.

The shooting component is used for shooting videos.

The second memory is used to store a computer program that can be run on the second processor.

The second processor is used to execute the operations of the aforementioned shooting method when running the computer program.

An implementation of the present disclosure provides a storage medium, which stores a computer program that, when executed by a processor, implements the operations of the aforementioned video processing method or shooting method.

An implementation of the present disclosure provides a computer program product, including a computer program, which, when executed by a processor, implements the operations of the aforementioned video processing method or shooting method.

The present disclosure provides a video processing method, a shooting method, an image processing device, an imaging apparatus, a storage medium, and a computer program product. The video processing method includes: adjusting the expected video picture of the video to be processed in response to detecting an operation of a joystick; generating a target video according to the expected video picture, where the picture of the target video corresponds to the expected video picture; and saving the target video. The solution provided by some implementations of the present disclosure can be applied to scenarios where shooting occurs before framing and can also be applied to shooting scenarios, at least adding a joystick framing method, which is simple to operate and improves the quality of the final video.

### BRIEF DESCRIPTION OF DRAWINGS

FIG. 1 is a flowchart of a video processing method, according to some implementations of the present disclosure.

FIG. 2 is a schematic diagram of operating a joystick, according to some implementations of the present disclosure.

FIG. 3 is a schematic diagram of a transition curve, according to some implementations of the present disclosure.

FIG. 4 is a first schematic diagram of icon display on a recording page, according to some implementations of the present disclosure.

FIG. 5 is a second schematic diagram of icon display on a recording page, according to some implementations of the present disclosure.

FIG. 6 is a third schematic diagram of icon display on a recording page, according to some implementations of the present disclosure.

FIG. 7 is a fourth schematic diagram of icon display on a recording page, according to some implementations of the present disclosure.

FIG. 8 is a schematic diagram displaying prompt information and selection buttons on a recording page, according to some implementations of the present disclosure.

FIG. 9 is a structural schematic diagram of a video processing device, according to some implementations of the present disclosure.

FIG. 10 is a structural schematic diagram of an imaging apparatus, according to some implementations of the present disclosure.

FIG. 11 is a structural schematic diagram of an image processing device, according to some implementations of the present disclosure.

FIG. 12 is a structural schematic diagram of an imaging apparatus, according to some implementations of the present disclosure.

Some implementations of the present disclosure will be described with reference to the accompanying drawings.

### DETAILED DESCRIPTION

To make the objectives, technical solutions, and advantages of the present disclosure clearer, the following will provide a detailed description of the present disclosure in conjunction with the accompanying drawings. The described implementations should not be considered as limitations to the present disclosure. All other implementations obtained by those skilled in the art without creative efforts fall within the scope of the present disclosure.

In the following description, references to “some implementations” describe a subset of all possible implementations. It is understood that the term, “some implementations,” may refer to the same or different subsets of all possible implementations and may be combined with each other without conflict.

In the following description, the terms, “first,” “second,” and “third,“ are merely used to distinguish similar objects and do not represent a specific order for the objects. It is understood that the terms ”first,” “second,” and “third,” can be interchanged in specific order or sequence where allowed, so that the implementations of the present disclosure described here can be implemented in an order other than what is illustrated or described here.

Unless otherwise defined, all technical and scientific terms used herein have the same meaning as commonly understood by one of ordinary skill in the art to which the present disclosure belongs. The terms used herein are for the purpose of describing the implementations of the present disclosure and are not intended to limit the present disclosure.

The implementations of the present disclosure provide a video processing method. In some implementations, the hardware end implementing the video processing method can be an image processing device or an imaging apparatus. When the hardware end is an image processing device (such as a tablet, laptop, personal digital assistant, or smartphone), the user needs to input the recorded panoramic video into the computer or smartphone for processing. When the hardware end is an imaging apparatus (such as a panoramic camera), the recorded panoramic video can be processed directly.

In some implementations, the imaging apparatus may include a touch display screen, lens, image sensor, motion sensor, processor, and a housing assembly carrying one or more of the above devices.

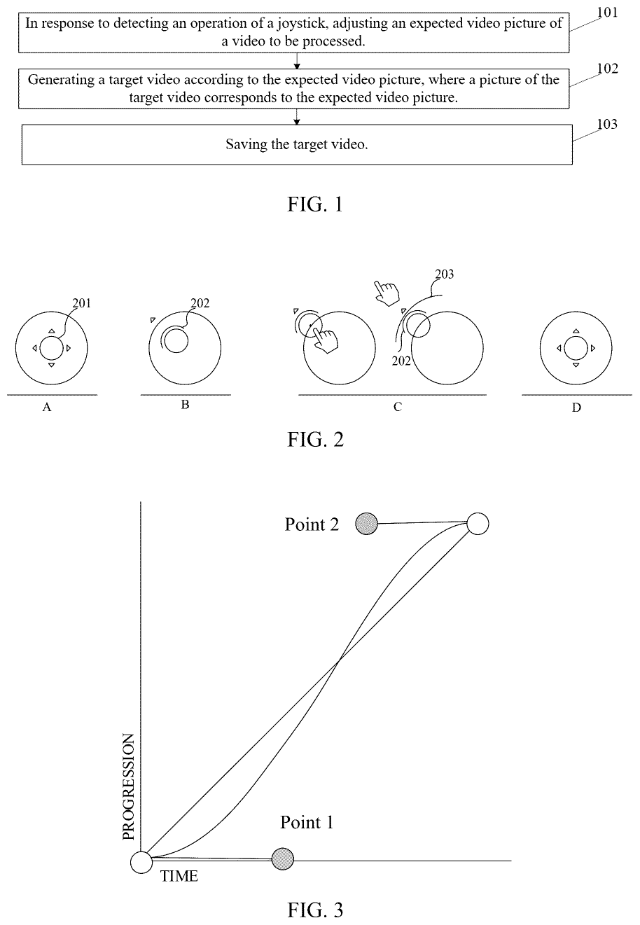

As shown in FIG. 1, in one implementation, the video processing method includes:

Operation 101: In response to detecting an operation of a joystick, adjusting an expected video picture of a video to be processed.

In some implementations, the joystick may be a joystick displayed on the touch screen of the hardware end (such as a virtual joystick). The joystick may also be a joystick connected to the hardware end (such as a physical joystick), and the user's operation on the joystick is presented on the display screen of the hardware end.

In some implementations, the video to be processed may be a panoramic video, and the expected video picture corresponds to the Field of View (FOV) of the video. The solution provided by some implementations of the present disclosure can be applied to scenarios where shooting occurs before framing (free recording scenarios), focusing on real-time creation without considering framing issues, and freely selecting the desired angle during post-editing. The solution provided by some implementations of the present disclosure can also be applied to shooting scenarios, framing the picture captured by the imaging apparatus's actual field of view during recording to obtain the desired final video.

In an achievable free recording scenario, after entering the free recording mode, the user operates the joystick, and the image processing device (such as a smartphone) responds to the detection of the joystick operation by adjusting the expected video picture of the video to be processed, adjusting the desired picture into the viewfinder. The newly added joystick framing method of the present disclosure improves the stability of operation during the recording process compared to the method of shaking the smartphone significantly.

Operation 102: Generating a target video according to the expected video picture, where a picture of the target video corresponds to the expected video picture.

In some implementations, for the video to be processed (such as a panoramic video), the desired at least one view angle is freely selected through joystick framing, and the expected video picture is adjusted into the viewfinder to generate a target video (including at least one flat video).

Operation 103: Saving the target video.

In some implementations, after generating the target video, the target video is saved. At this time, at least one recording segment can be saved to the system album. At least one finished video obtained through joystick framing during recording can also be saved to the system album. It is also possible to merge the recording segments/finished videos through the “Create New Story” option in the export options for editing and then saving.

In some implementations, after generating the target video, the recorded segments are stored in the system album, and the number of segments in the album can also be displayed. When the user clicks on the album, the hardware end enters a secondary page, which supports playing and trimming the recorded segments.

The video processing method provided by some implementations of the present disclosure includes: in response to detecting an operation of a joystick, adjusting the expected video picture of the video to be processed; generating a target video according to the expected video picture, where the picture of the target video corresponds to the expected video picture; saving the target video. The solution provided by some implementations of the present disclosure can be applied to scenarios where shooting occurs before framing and to shooting scenarios, at least adding a joystick framing method, which is simple to operate and improves the quality of the final video.

In some implementations, the above method further includes: displaying the adjusted expected video picture.

Here, the object of adjustment can be the main bitstream, and the object of the display can be the main bitstream or the auxiliary bitstream. The main bitstream has a large bitstream, and the corresponding frame picture has a higher resolution. The auxiliary bitstream has a small bitstream, and the corresponding frame picture has a lower resolution. The main bitstream and the auxiliary bitstream correspond to the same video file, and the content of the frame picture is the same, only the bitstream size and the corresponding frame picture resolution are different.

Here, the timing of adjustment and display can be the same or different. For example, in response to detecting an operation of a joystick, while adjusting the expected video picture of the video to be processed, the adjusted expected video picture is displayed. Alternatively, the display is delayed by at least one frame compared to the adjustment.

The present disclosure does not specifically limit the bitstream relationship of the objects of adjustment and display and the timing relationship of adjustment and display.

In some implementations, after operation 101 responds to detecting an operation of a joystick, the method further includes at least one of the following:
if a sliding operation on a touch screen is detected, making no response to the sliding operation; and
if a somatosensory interaction operation is detected, making no response to the somatosensory interaction operation.

In some implementations, a sliding operation may be an operation of sliding a finger on the screen of the touch screen in the recording mode. The sliding operation corresponds to a sliding framing method, changing the view angle according to the sliding direction, etc. A somatosensory interaction operation may be an operation of changing the posture of the hardware end through somatosensory interaction in the recording mode. The somatosensory interaction operation corresponds to a gravity/somatosensory framing method, changing the view angle according to the gyroscope parameters by changing the posture of the hardware end.

In an achievable framing scenario, sliding (finger sliding) framing/somatosensory (gyroscope) framing/joystick framing is supported, and when joystick framing is used, other framing methods are not responded to. It can be seen that the present disclosure supports multiple framing methods. In this implementation, when joystick framing is used, other framing methods are blocked.

In another achievable framing scenario, sliding (finger sliding) framing/somatosensory (gyroscope) framing/joystick framing is supported, and when joystick framing is used, sliding framing is not responded to, but gyroscope framing is compatible. It can be seen that the present disclosure supports multiple framing methods. In this implementation, when joystick framing is used, sliding framing is blocked, and a new framing method, namely joystick and somatosensory compatible mode, is provided.

In yet another achievable framing scenario, sliding (finger sliding) framing/somatosensory (gyroscope) framing/joystick framing is supported, and sliding framing is compatible with gyroscope framing.

If the user can try multiple framing methods on the video to be processed to generate different flat videos, the framing function is expanded while providing multiple interaction methods.

In some implementations, when the joystick framing function is enabled, other framing methods are blocked by default. The user can manually enable multiple framing methods supported by the hardware end on the settings page to achieve multi-method superimposed framing. The framing methods supported by the present disclosure include: joystick framing, finger sliding framing, somatosensory framing, joystick plus somatosensory framing, and finger sliding plus somatosensory framing.

In some implementations, operation 101, in response to detecting an operation of a joystick, adjusting the expected video picture of the video to be processed, includes:
in response to detecting an operation of a joystick displayed on the touch screen, adjusting a speed of angle rotation corresponding to a gear according to a parameter generated based on the movement of the joystick, to adjust the expected video picture of the video to be processed, where there is a one-to-one relationship between the gear and a range to which the parameter belongs.

In the implementations of the present disclosure, there is a one-to-one relationship between the gear and the range to which the parameter generated by the movement of the joystick belongs. Thus, according to the parameter generated by the movement of the joystick, the speed of angle rotation is adjusted to the parameter corresponding to the gear. In this way, flexible adjustment of the speed of angle rotation is achieved.

In some implementations, a joystick (virtual joystick) is displayed on the recording page of the touch screen, and the user operates the joystick, and the hardware end obtains the parameter generated by the movement of the joystick.

In some implementations, the parameter generated by the movement of the joystick includes but is not limited to the offset of the joystick movement, which is the distance between the initial point and the end point. The offset can also be called the lever quantity. The user's operation of the joystick causes the lever quantity to change linearly within a certain range. The direction of the line connecting the initial point and the end point determines the movement direction of the viewfinder. In actual operation, when the joystick is triggered, a direction cursor appears according to the actual dragging direction, providing directional feedback.

In an achievable joystick framing scenario, the speed of angle rotation has a linear mapping relationship with the distance between the initial point and the end point. For example, for a touch screen, the farther the joystick is pulled by the finger, the faster the view angle switches. Of course, the speed of angle rotation can also form other mapping relationships with the distance between the initial point and the end point, such as a step change relationship, which is a non-continuous change relationship.

Here, the speed of angle rotation can be calculated as follows: angle rotated per second (degrees/S)=distance (px)×specific parameter, where the specific parameter is used to achieve the mapping from distance to speed, and px refers to pixels. The parameter corresponding to the distance (px) can be 0.85 cm.

When the virtual joystick's offset is from 0 to the maximum value, the mapped speed can be [0,2], with a maximum of 2× speed. The [0,2] interval can be divided into 6 gears. The present disclosure does not specifically limit the number of gears or the speed of angle rotation corresponding to the gears.

Refer to FIG. 2, where A in FIG. 2 shows the default state, the joystick user interface (“UI”) is displayed, and the center of the joystick UI is an operation ball 201, in some implementations showing arrows in four operation directions. B in FIG. 2 shows the operation movement state, highlighting (indicated by a short arc line 202 here) the operation direction and displaying the arrow direction. C in FIG. 2 shows the operation ball moving to the limit value; the operation ball's center movement range is limited within the circle area; even if the finger slides out of the circle, the operation ball UI display still does not exit the circle; in some implementations, when the finger slides to the extreme position, the UI displays a warning color to remind the slide to the extreme position (indicated by a long arc line 203 here), and a strong vibration reminder is performed at this time. D in FIG. 2 shows the release gesture, after releasing, the operation ball returns to the center position of the joystick, called recentering.

In an achievable joystick framing scenario, a lever quantity upper limit is set, which can be 100 px. After the moving distance exceeds this length, the speed of angle rotation no longer increases, and the lever quantity upper limit can be set according to actual needs, thereby achieving flexible adjustment and reasonable control of the speed of angle rotation.

In some implementations, the joystick's direction adjustment operation is synchronized with the movement of the viewfinder in real-time, allowing the user to receive timely feedback.

In some implementations, the speed needs to ease out at the end of a single joystick operation. Referring to FIG. 3, the present disclosure can achieve the ease-out effect according to the ease curve. The horizontal axis of the figure represents time (TIME), and the vertical axis represents progression (PROGRESSION). The horizontal axis time is a proportional time, with units in percentage (%). The vertical axis represents the progression of attribute changes, also in percentage (%). Both axes range from 0 to 1 (0 % to 100%). By freely moving points 1 and 2, the control points, the corresponding animation curve can be obtained. Thus, after the joystick operation ends, it does not stop suddenly but stops slowly according to the ease curve, making the picture smoother.

In some implementations, when the finger operates the joystick to slide to the extreme position, the virtual joystick UI displays a warning color, and a strong vibration reminder is performed at the extreme value.

In some implementations, operation 101, in response to detecting an operation of a joystick, adjusting the expected video picture of the video to be processed, includes:
in response to detecting an operation of a joystick displayed on the touch screen, adjusting the expected video picture of the video to be processed according to the movement direction of the joystick; and
in response to detecting a trigger operation of a preset view angle, moving the joystick on the touch screen to an initial position, and adjusting the expected video picture of the video to be processed according to the preset view angle.

In some implementations, when the user frames with the joystick by sliding, clicking one of the preset view angles, the smartphone responds to the detection of the trigger operation of the preset view angle, moving the joystick to the initial position on the touch screen. At this time, the joystick returns to the center, and the picture responds to the preset view angle, adjusting the expected video picture of the video to be processed according to the preset view angle. Subsequently, when the user operates the joystick again, it responds to the joystick.

In some implementations, the above method further includes:
in response to detecting an operation of a view angle icon of a preset view angle displayed on the touch screen, adjusting the expected video picture of the video to be processed according to the preset view angle, where the preset view angle includes one of a protagonist view angle, a forward view angle, or a panoramic view angle.

Here, the protagonist view angle is a view angle of one or more objects in a shooting range of an imaging apparatus, or a view angle of one or more objects determined according to the parameter information; the forward view angle is a view angle in a moving direction of the imaging apparatus; and the panoramic view angle is a view angle that rotates 360 degrees along a horizontal direction from a current picture.

In some implementations, a view angle icon of the preset view angle is displayed on the touch screen. When the user clicks one of the preset view angles, the expected video picture of the video to be processed is adjusted according to the selected preset view angle. During recording, the user can choose one preset view angle or flexibly switch between multiple preset view angles. By clicking the view angle preset option, the corresponding picture is smoothly transitioned according to the definition of each option.

In some implementations, switching view angles requires a smooth transition to the corresponding picture content, achieved by setting a target duration (e.g., 0.3 seconds) for easing in and out. During smoothing, user operations are not blocked. During smoothing, user touches on the screen/joystick/other view angle buttons will interrupt smoothing, and somatosensory is blocked during smoothing; after interruption/smoothing ends, somatosensory response is restored. When generating the target video, i.e., during recording, clicking the view angle preset option (e.g., forward view angle/protagonist view angle) switches to the corresponding view angle after the smooth time.

In some implementations, the preset view angle is the panoramic view angle, and in response to detecting an operation of the view angle icon of the preset view angle displayed on the touch screen, adjusting the expected video picture of the video to be processed according to the preset view angle includes:
in response to detecting an operation of the view angle icon of the panoramic view angle, adjusting a shooting scene of the video to be processed to rotate along a horizontal direction according to the panoramic view angle, and adjusting the expected video picture of the video to be processed according to the target view angle after rotation ends,
where the target view angle is the selected protagonist view angle or the selected forward view angle before the detection of the operation of the view angle icon of the panoramic view angle, or the target view angle is the view angle selected according to the joystick before the detection of the operation of the view angle icon of the panoramic view angle.

In some implementations, the panoramic view angle is also called 360 panoramic. Clicking the panoramic view angle adjusts the shooting scene of the video to be processed to rotate along a horizontal direction according to the panoramic view angle to adjust the expected video picture of the video to be processed. If there is a preset view angle before the rotation, it returns to the preset view angle. If there is no preset view angle before the rotation, it returns to the view angle selected by the joystick. After the horizontal panoramic ends, it can return to the picture before the panoramic, or it can return to a picture during the panoramic process, i.e., after 360 panoramic, it may not be the current picture. The present disclosure does not specifically limit this.

In some implementations, during the panoramic process, somatosensory is blocked; during the panoramic process, other operations are not blocked, for example, user operation of the joystick will interrupt the panoramic.

In some implementations, during the panoramic process, clicking record does not interrupt the panoramic and continues recording, continuing the remaining panoramic progress. After ending, without other operations, it slows down to stop near 360 degrees.

In some implementations, clicking 360 panoramic, during the panoramic process, back and forth seek is not blocked. After the seeking, the 360 panoramic icon returns to the default state (not highlighted), seeking the picture of the view angle before seeking the corresponding frame. Here, Seek refers to the Seek command, which is the command to move to the specified frame.

In some implementations, during the panoramic process, when jumping (jumpcut), the switching of the preset view angle continues 360 panoramic regardless of the jump change of picture content.

In some implementations, during the panoramic process, the 360 panoramic button supports clicking, the picture stays at the current view angle, the icon returns to the normal state, not highlighted, the progress is reset, and clicking again starts the panoramic from 0 degrees, that is, after pausing during the panoramic, if panoramic is triggered again, it can start from 0 degrees.

In some implementations, during the panoramic process, after clicking the selected 360 panoramic icon button, the current rotation progress can be displayed on the icon.

In some implementations, the above method further includes:
obtaining parameter information saved during shooting of the video to be processed or after shooting of the video to be processed, where the parameter information includes path information and/or view angle information, and the parameter information is configured to implement the operation of the preset view angle; and
displaying, on the touch screen, one or a combination of a plurality of a view angle icon of the protagonist view angle, a view angle icon of the forward view angle, or a view angle icon of the panoramic view angle according to the parameter information,
where the protagonist view angle is the view angle of one or more objects in a shooting range of an imaging apparatus, or a view angle of one or more objects determined according to the parameter information, where the forward view angle is a view angle in a moving direction of the imaging apparatus, and the panoramic view angle is a view angle that rotates 360 degrees along a horizontal direction from a current picture.

In some implementations, the above parameter information includes path information and/or view angle information, which is data recorded by the material file of the imaging apparatus (such as a camera). It can be recorded at the end of the material file. After the camera's Artificial Intelligence (AI) assistant is turned on, during the user's shooting of the material, the AI algorithm analyzes while shooting, generating parameter information during/after shooting, which can be stored at the end of the file. The application program (APP) of the smartphone reads the data at the end of the corresponding file, and the icon can be displayed in a “normal state” where there is data, and in a “gray state” where there is no data. It is possible that not the entire video has analysis data. It is possible that some parts have it, and some parts do not. Thus, the presentation of the preset view angle can be controlled according to the parameter information, appearing all icons corresponding to the parameter information where the material has the corresponding parameter information, and not appearing where the material does not have the corresponding parameter information. The remaining icon positions can be flexibly moved up/maintained in a fixed position.

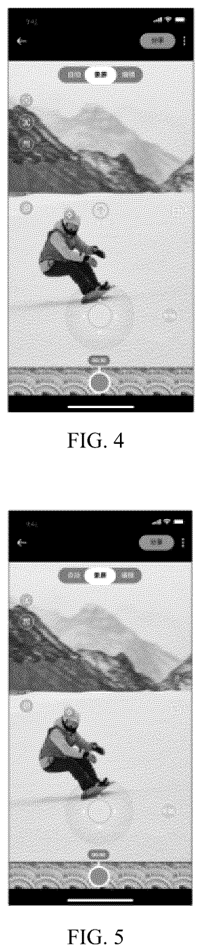

In an achievable scenario of flexibly displaying preset view angle icons, refer to FIGS. 4 to 7, taking a video segment with multiple discontinuous parameter information as an example to explain the display of preset view angle icons. Refer to FIG. 4, in the case where the parameter information of the video segment is used to implement the operation of the forward, host view angle, the relevant icons are displayed on the recording page according to the rule: from top to bottom on the left side: forward direction, protagonist view angle, 360 panoramic, zoom (magnifying glass). On the entire timeline, the user can click the forward direction/protagonist view angle icon at any time.

Refer to FIG. 5. In the case where the parameter information of the video segment is used to implement the operation of the protagonist view angle, the display rules of the relevant icons on the recording page are: from top to bottom on the left side: protagonist view angle, 360 panoramic, zoom (magnifying glass). This means that, in this scenario, the video at this stage contains time periods without forward direction data, and the user cannot click the forward direction icon, making it impossible to enable forward tracking at this time.

It should be noted that from the time with forward direction data to the time without forward direction data, the view angle remains at the view angle of the last frame of the forward direction data time period and continues tracking.

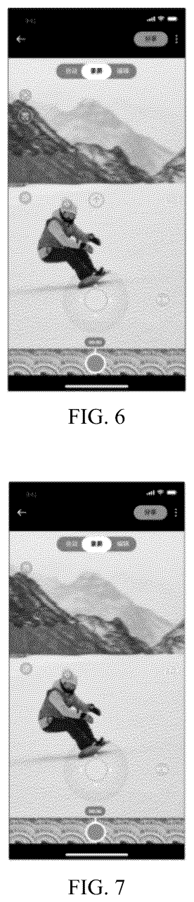

Refer to FIG. 6. In the case where the parameter information of the video segment is used to implement the operation of the forward view angle, the display rules of the relevant icons on the recording page are: from top to bottom on the left side: forward direction, 360 panoramic, zoom (magnifying glass). This means that, in this scenario, the video at this stage contains time periods without protagonist data, and the user cannot click the protagonist view angle icon.

Refer to FIG. 7. In the case where the parameter information of the video segment is missing, the display rules of the relevant icons on the recording page are: from top to bottom on the left side: 360 panoramic, zoom (magnifying glass). This means that, in this scenario, the video at this stage contains time periods without forward direction or protagonist data, and the user cannot click the forward direction or protagonist view angle icons.

In some implementations, zoom can overlap with forward, protagonist, panoramic, or transition states. Zoom refers to zooming based on the center of the picture. Unlike the joystick or finger sliding, the zoom does not change the center of the picture. During actual recording/shooting, zoom can be performed while moving the camera.

In some implementations, zoom can refer to adjusting the proportion of the displayed picture content in the original picture content, such as electronic (digital) zoom.

In some implementations, generating a target video according to the expected video picture includes:
if the set duration of the target video is less than or equal to the actual duration of rotating 360 degrees along a horizontal direction, generating the target video according to the expected video picture and the set duration, where the target video includes a video picture corresponding to the expected field of view within the set duration; and
if the set duration of the target video is greater than the actual duration, generating the target video according to the expected video picture and the actual duration, where the target video includes a video picture corresponding to the expected field of view within the actual duration and a supplementary picture within a remaining duration.

In some implementations, the 360 panoramic has a non-time-freezing effect, and the picture contained in the generated target video is determined by the set duration. When the set duration is greater than the actual duration, the 360-degree rotation ends at the above actual duration, and the remaining duration picture is filled/completed. When the set duration is less than or equal to the actual duration of rotating 360 degrees along a horizontal direction, there is no completion.

In some implementations, at least two video frames corresponding to the supplementary picture are obtained according to the same video frame of the video to be processed, and the content of at least two video frames is different.

In some implementations, the picture used for filling/completing includes at least two video frames, and the supplementary picture has a time-space lag effect.

In some implementations, the 360 panoramic has a non-time-freezing effect, which is sought while panoramic; in the case where the entire video duration is insufficient for a full panoramic, it stops at the end of the video. The last second no longer supports recording. In the case of insufficient time to rotate a full circle during recording, there is no need to gray out the 360 icon. In the paused state, clicking 360 panoramic in the last second is also a full circle of the current frame, and there is no need to gray out.

In some implementations, in response to detecting an operation of a joystick, adjusting the expected video picture of the video to be processed includes:
in response to detecting a somatosensory interaction operation, adjusting the expected video picture of the video to be processed according to a somatosensory change magnitude corresponding to the somatosensory interaction operation; and
if the somatosensory change magnitude corresponding to the somatosensory interaction operation is less than a preset threshold, in response to detecting an operation of the joystick, adjusting the expected video picture of the video to be processed according to the movement direction of the joystick.

In some implementations, in the scene of somatosensory framing, the joystick framing method can also be superimposed to provide a new framing mode. When the detected somatosensory change magnitude corresponding to the somatosensory interaction operation is less than a preset threshold, and the operation of the joystick is detected, the expected video picture of the video to be processed is adjusted according to the movement direction of the joystick. For example, during the user's somatosensory framing process, turning may turn 90 degrees, and then the joystick is used to continue turning. At this time, the joystick power accumulation framing is realized, which is convenient for user operation. At the same time, using the joystick power accumulation determination method provided by some implementations of the present disclosure, the precise realization of joystick framing operation after somatosensory framing is achieved.

In some implementations, in response to detecting an operation of a joystick, adjusting the expected video picture of the video to be processed includes:
detecting a somatosensory interaction operation during a process of responding to the detection of the operation of the joystick; and
adjusting the expected video picture of the video to be processed according to a superposition result of a control quantity of the joystick and a control quantity of the somatosensory interaction operation.

In some implementations, framing control can be achieved through the superposition result of somatosensory plus joystick. That is to say, the control factor for adjusting the expected video picture of the video to be processed is the superposition result of the control quantity of the joystick and the control quantity of the somatosensory interaction operation. In this way, the final control result can be purely controlled by the joystick, or it can be the original somatosensory motion inertia, or the superposition of the original somatosensory default path and the joystick. In other words, the intervention of the joystick can fully obtain control rights, or it can be superimposed control on the basis of the original somatosensory control.

In some implementations, the control quantity of the joystick and the somatosensory interaction operation can be a vector, and the superposition result is the superposition of two vectors, i.e., the vector sum.

In some implementations, during the process of responding to the detection of an operation of the forward view angle, the operation of the joystick is detected; and

the expected video picture of the video to be processed is adjusted according to a superposition result of a lever quantity of the joystick and a view angle direction of the forward view angle.

In some implementations, the user clicks the forward view angle to adjust the picture in front to the viewfinder. At this time, the user touches the joystick, and the expected video picture is adjusted according to the superposition result of the lever quantity of the joystick and the view angle direction of the forward view angle, achieving superimposed adjustment of the view angle direction.

In some implementations, the superposition result of the view angle direction of the joystick and the forward view angle can be a vector, and the superposition result is the superposition of two view angle directions, i.e., the vector sum.

In some implementations, in response to detecting an operation of a joystick, adjusting the expected video picture of the video to be processed includes:
detecting a somatosensory interaction operation during a process of responding to the detection of the operation of the joystick;
if a change quantity of the movement of the joystick is greater than a change quantity of a somatosensory change magnitude of the somatosensory interaction operation, in response to the detection of the operation of the joystick, adjusting the expected video picture of the video to be processed by changing a view angle in a direction of the movement of the joystick,
where at this time, the joystick obtains the control right of the view angle, and the view angle is adjusted through the joystick to adjust the desired picture into the viewfinder.

If the change quantity of the movement of the joystick is less than the change quantity of the somatosensory change magnitude of the somatosensory interaction operation, in response to detecting a somatosensory interaction operation, the expected video picture of the video to be processed is adjusted by changing the view angle in a direction of the somatosensory interaction operation.

At this time, the somatosensory operation obtains the control right of the view angle, and the view angle is adjusted through the somatosensory operation to adjust the desired picture into the viewfinder.

If the change quantity of the movement of the joystick is equal to the change quantity of the somatosensory change magnitude of the somatosensory interaction operation, adjusting the expected video picture of the video to be processed according to an operation of maintaining the view angle.

At this time, the change quantities of the joystick and somatosensory are the same, so the view angle remains unchanged, and the current view angle picture is adjusted into the viewfinder as the desired picture.

In some implementations, in the framing scenario where the joystick and somatosensory are used simultaneously, the operation with the larger change quantity controls the change of the field of view angle; and if the change quantities are the same, the picture does not move. In this way, during the framing process, the timeliness and accuracy of the framing method switching are ensured.

In some implementations, in the framing scenario where the joystick and somatosensory are used simultaneously, the adjustment of camera movement and field of view angle is supported simultaneously. That is to say, the recording page displays preset view angles and a magnifying glass (FOV adjustment button). When the user clicks any of the 3 preset view angle icons, the clicked preset view angle is highlighted, and the gyroscope is blocked. When the preset view angle icon is highlighted, the gyroscope is blocked, but finger sliding or joystick is supported. However, finger sliding or operating the joystick will exit the preset view angle, causing the icon to change from a highlighted state to a normal state.

Here, an explanation is given for FOV. The FOV icon can reside on one side of the picture, and it does not disappear before, during, or after recording. Clicking/touching the FOV icon calls out the slider. It supports single-finger up-and-down sliding, changing the FOV based on the center of the current picture. The sliding up/down direction determines zoom in/out, and the sliding distance and FOV change value are mapped. The longer the sliding distance, the greater the FOV change value. The FOV range is the adjustable range of the FOV at the current ratio, changing uniformly according to the sliding distance of the FOV slider. The position is remembered after user adjustment. Lightweight vibration feedback is provided during sliding. The slider disappears after the operation of clicking/touching the FOV icon disappears, for example, after releasing the finger.

Here, the presentation between the slider and the FOV icon is described in the following three scenarios.
Scenario 1: In the absence of operation, the slider returns to the magnifying glass icon after staying for 1 second.
Scenario 2: During the one-second stay, the user can drag the slider button up and down. At this time, after dragging and releasing, it immediately returns to the magnifying glass (if it was expanded, just clicking the button also returns).
Scenario 3: During the one-second stay, clicking other areas does not retract the slider (the stay time itself is very short).

In some implementations, in response to detecting an operation of a joystick, adjusting the expected video picture of the video to be processed includes:
in response to detecting an operation of a view angle icon of a preset view angle displayed on the touch screen, adjusting the expected video picture of the video to be processed according to the preset view angle; and
in response to detecting an operation of the joystick, interrupting the preset view angle, and adjusting the expected video picture of the video to be processed according to the movement direction of the joystick.

In some implementations, when the user clicks one of the 3 preset view angles, the smartphone adjusts the framing picture according to the preset view angle. During this process, if the user touches the joystick, the preset view angle is interrupted, and the framing picture is adjusted according to the movement direction of the joystick.

In some implementations, in the case where the user selects the tracking view angle, triggering the joystick interrupts the tracking view angle, stops tracking the target picture, and continues recording according to the view angle picture selected by the joystick.

In some implementations, in response to detecting an operation of a joystick, adjusting the expected video picture of the video to be processed includes:
in response to detecting an operation of a view angle icon of a preset view angle displayed on the touch screen, adjusting the expected video picture of the video to be processed according to the preset view angle;
in response to detecting an operation of the joystick, adjusting the expected video picture of the video to be processed according to the movement direction of the joystick; and
if the operation of the joystick is cancelled, adjusting the expected video picture of the video to be processed according to the preset view angle.

In some implementations, when the user clicks one of the 3 preset view angles, the smartphone adjusts the framing picture according to the preset view angle. During this process, if the user touches the joystick, the framing picture is adjusted according to the movement direction of the joystick. Further, when the operation of the joystick is detected to be cancelled, for example, when the user's finger releases the joystick, it returns to the previous preset view angle and continues to adjust the framing picture according to the preset view angle.

In some implementations, in the case where the user selects the tracking view angle, triggering the joystick, it records according to the view angle picture selected by the joystick. When the operation of the joystick is cancelled, it returns to the tracking view angle and continues tracking recording of the target.

In some implementations, the above method further includes:
in response to detecting a key frame selection operation by a user, determining at least two key frames of the video to be processed;
in response to detecting an operation of the joystick, adjusting a transition manner between the at least two key frames in the video to be processed according to a lever quantity of the joystick and a transition curve between the at least two key frames,
where the transition curve can be one selected by the user from multiple selectable transition curves or a default transition curve.

In some implementations, a transition curve is presented on the recording page, which can be a default transition curve, an algorithmically generated curve, or one selected by the user from multiple selectable transition curves. Further, the user operates the joystick to adjust the transition manner between the two key frames in the video to be processed according to the lever quantity and the transition curve, achieving a smooth transition effect. In some implementations, it is the superposition of the control quantity of the lever and the transition curve.

In other implementations, multiple key frames can be determined first, and the user then adjusts the transition manner between multiple key frames to generate the target video; or multiple key frames are determined first, and a first video is generated based on the key frames, and finally, the user adjusts the first video with the joystick to generate the target video.

Here, after responding to the detection of the user's key frame selection operation and determining at least two key frames of the video to be processed, the transition picture can also be adjusted in the following way.

In response to clicking the preset curve operation, detecting the user's finger sliding operation on the touch screen, and adjusting the transition manner between the two key frames in the video to be processed according to the data generated by the finger sliding and the transition curve between the key frames. That is to say, the present disclosure can adjust the transition picture through the joystick, and it can also adjust the transition manner through other ways, which is not specifically limited in the present disclosure.

In some implementations, generating a target video according to the expected video picture includes:
obtaining reference information, where the reference information includes one or more of the following: video specification information of the video to be processed, processing capability information of an image processing device, playback performance selection information input by a user, or video information of the video to be processed;
determining a video generation mode according to the one or more pieces of information in the reference information; and
processing the expected video picture according to the determined video generation mode to generate the target video.

In some implementations, the video specification information of the video to be processed includes but is not limited to resolution, bit rate, and other specification requirements. The processing capability information of the image processing device is determined by one or more factors such as the model of the image processing device and the processing chip it carries. The playback performance selection information input by the user includes but is not limited to the video specifications selected by the user. The video information of the video to be processed includes but is not limited to the above parameter information (path information and/or view angle information). Among them, the hardware end can store a recording whitelist model, and for models within the recording whitelist, the performance mode popup is not displayed; for models outside the recording whitelist, the performance mode popup is displayed. In this way, the user can choose whether to turn on the performance mode switch through human-computer interaction.

In some implementations, when the user inputs playback performance selection information, a one-way prompt box (such as a Toast popup) can be used to pop up a reminder, and the user cannot interact with the prompt box.

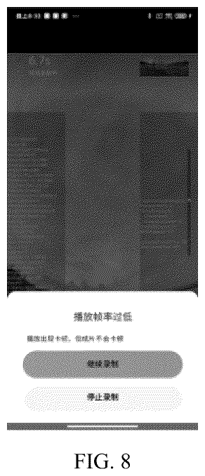

In some implementations, user operations can also be received while prompting. Refer to FIG. 8, which prompts that the playback frame rate is too low, causing playback stuttering, but the final video will not stutter. This page provides two selection buttons, continue recording and stop recording. If the user chooses to continue recording, recording continues.

Here, the video generation mode includes one of the following:
(1) When saving in a cache, generating a flat video based on the expected video picture corresponding to a main bitstream of the video to be processed and an operation result of adjusting the expected video picture of the video to be processed; that is, main bitstream recording, recording and editing immediately, obtaining a flat video, where recording/recording refers to the process of framing a panoramic video to generate a flat video.
(2) Saving, in a cache, an operation result of adjusting the expected video picture of the video to be processed, and when exporting, generating a flat video based on the expected video picture corresponding to an auxiliary bitstream of the video to be processed and the operation result; that is, first save the user's operation result, and when exporting, perform “recording” processing on the expected video picture corresponding to the auxiliary bitstream of the video to be processed according to the operation result to obtain a flat video.
(3) Saving, in a cache, the operation result, and when exporting, generating a flat video based on the expected video picture corresponding to a main bitstream of the video to be processed and the operation result; that is, first save the user's operation result, and when exporting, perform “recording” processing on the expected video picture corresponding to the main bitstream of the video to be processed according to the operation result to obtain a flat video. In some implementations, the operation result can be the path information of the field of view confirmed after the user operates the joystick.

In an achievable scenario, the specification requirement of the video to be processed is low specification (5.7K 60 frames and below), with the highest priority: providing a performance mode switch, where performance mode on executes scheme one (recording and editing immediately), and performance mode off executes scheme two (exporting and editing).

In one implementation, performance mode on executes scheme one (models outside the panoramic specification whitelist, with crash risk), performance mode off executes scheme two.

In one implementation, both scheme one and scheme two are main bitstream recording & editing.

For models within the recording whitelist: the performance mode popup is not displayed, scheme one refers to main bitstream recording & editing; switching to auxiliary bitstream, then auxiliary bitstream recording auxiliary bitstream editing (or main bitstream recording & editing).

For models outside the recording whitelist: the performance mode popup is displayed, the user chooses to turn on performance mode; in scheme one, the user chooses to turn off performance mode, and snap can still be used; but when scheme two is used, main bitstream recording, exporting and editing later, exporting requires waiting.

In an achievable scenario, the specification requirement of the video to be processed is high specification (5.7K60 frames and above) with the highest priority: performance mode switch, performance mode on executing scheme one (models outside the panoramic specification whitelist, with crash risk), and performance mode off executing scheme two.

For models within the recording whitelist: the performance mode popup is not displayed, auxiliary bitstream recording, main bitstream exporting and editing later; scheme two is controlling expectations, i.e., reminding the user that the current preview is being viewed, and the picture quality is better after exporting; and after turning on the performance mode on the APP settings page, scheme one is adopted, switching to auxiliary bitstream, then auxiliary bitstream recording auxiliary bitstream editing (or main bitstream recording & editing).

For models outside the recording whitelist: the performance mode popup is displayed, the user chooses to turn on performance mode, scheme one being adopted (models outside the panoramic specification whitelist, with crash risk); the user chooses to turn off performance mode, snap can still be used, but scheme two is used, which is auxiliary bitstream recording, exporting and editing later, and exporting requires waiting, controlling expectations, i.e., reminding the user that the current preview is being viewed, and the picture quality is better after exporting.

In some implementations, the above method further includes:
obtaining path information in a first time period, where the path information is related to a control quantity of the joystick in the first time period;
smoothing the path information; and
determining the expected video picture according to the path information.

In some implementations, smoothing the path information is to reduce fast or shaky joystick movements, to obtain the true joystick path.

In some implementations, smoothing can be achieved through low-pass filtering, using a low-pass filter to remove jitter motion, and the filtered path is the true expected motion path.

In some implementations, smoothing can also be achieved by fitting a curve, using least squares to fit a curve function, and then recalculating the path information according to the curve function to obtain the true expected motion path.

In some implementations, the above method further includes:
smoothing the path information after the target video is generated.

In some implementations, image processing devices with poor performance (e.g., processing capability being below a threshold) can perform smoothing of the path information after generating the target video, i.e., smoothing during idle time, temporarily sacrificing precision to quickly produce the video.

In some implementations, the above method further includes:
when determining, according to the path information, that the path information is zero motion path information, adjusting the path information in view of the zero motion path information, so that the path information in the first time period represents zero motion.

In some implementations, the zero motion path is determined as zero motion or non-zero motion by analyzing the characteristics of the path filtered by low-pass filtering.

In some implementations, path information can also be determined, and when determining, according to the path information, that the path information is zero motion path information, the path information is adjusted in view of the zero motion path information, so that the path information in the first time period represents zero motion, achieving precise determination of the path information, and then confirming the expected video picture based on the determination result. In this way, the operation of sliding the joystick is not responded to for zero motion, avoiding a certain deviation between actual operation and intended operation, reducing the response to zero motion events in actual operation, and improving the accuracy of view angle change.

In some implementations, the above method further includes:
in a process of generating the target video, pausing the execution of generating the target video in response to detecting a pause operation input by a user;
in response to detecting a resume operation input by the user, resuming the execution of generating the target video; and
in a process of generating the target video, cancelling the execution of generating the target video in response to detecting a cancel operation input by the user.

In some implementations, during the process of generating the target video, the user can flexibly operate the progress of generating the target video, etc. For example, the user can pause recording, and the smartphone responds to detecting a pause operation input by the user by pausing the execution of generating the target video. It can also continue the execution of generating the target video after detecting a resume operation; or the user can cancel recording, and the smartphone responds to detecting a cancel operation input by the user by cancelling the execution of generating the target video. Compared with the long-duration framing solutions in related technologies, the pause, resume, and cancel of recording can be flexibly controlled, avoiding uninterrupted human-computer interaction over long periods, and optimizing the human-computer interaction mode during the recording process.

In an achievable free recording scenario, the user can quickly produce the video through the following behavior path: click the recording page—slide the page/adjust the view angle size—play and browse the entire video—select segment (provide marker point to assist selection)—start recording at the appropriate node—determine the view angle position through joystick/somatosensory/finger sliding (single framing method/multiple framing methods compatible)—click to end recording (support pause/resume)—view recording segment (support picture smoothing)—perform delete/trim—perform further editing (support further editing of materials, beautification, color adjustment, filters, etc.)—export.

The implementation of the present disclosure provides a shooting method, which includes: when an imaging apparatus is in a video recording state, performing the operations of the aforementioned image processing method, where the video to be processed is a video recorded by the imaging apparatus in the video recording state.

It should be noted that the description of the same operations and the same content in this implementation and other implementations can refer to the description in other implementations, and will not be repeated here.

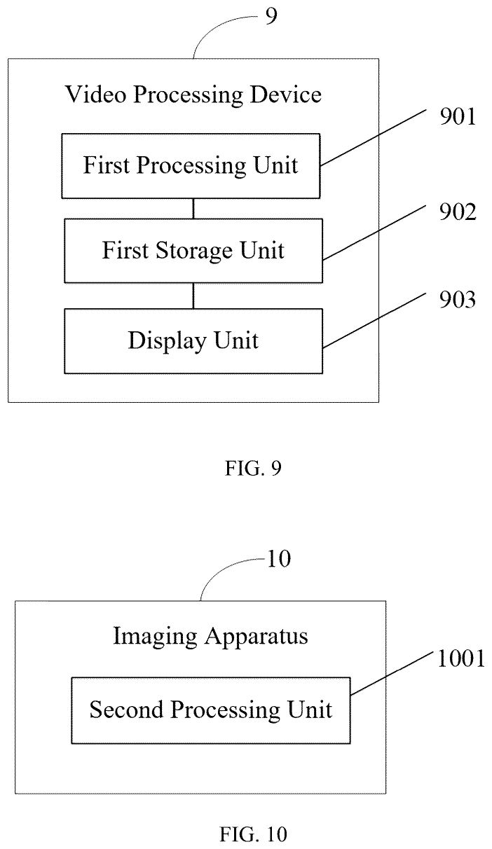

The implementations of the present disclosure provide a video processing device, which can be applied to a video processing method provided in the implementation corresponding to FIG. 1. As shown in FIG. 9, the video processing device 9 includes:
a first processing unit 901, configured to adjust the expected video picture of the video to be processed in response to detecting an operation of a joystick,
where the first processing unit 901 is configured to generate a target video according to the expected video picture, and
where the picture of the target video corresponds to the expected video picture; and
a first storage unit 902, configured to save the target video.

In some implementations, the video processing device 9 further includes: a display unit 903, configured to display the adjusted expected video picture.

In some implementations, the first processing unit 901 is configured to, after detecting an operation of the joystick, perform at least one of the following: if a sliding operation on a touch screen is detected, make no response to the sliding operation; and if a somatosensory interaction operation is detected, make no response to the somatosensory interaction operation.

In some implementations, the first processing unit 901 is configured to adjust the expected video picture of the video to be processed by adjusting the speed of angle rotation corresponding to a gear according to a parameter generated based on the movement of the joystick, in response to detecting an operation of a joystick displayed on the touch screen; and there is a one-to-one relationship between the gear and the range to which the parameter belongs.

In some implementations, the first processing unit 901 is configured to adjust the expected video picture of the video to be processed according to the movement direction of the joystick, in response to detecting an operation of a joystick displayed on the touch screen; and the first processing unit 901 is configured to, in response to detecting a trigger operation of a preset view angle, move the joystick to an initial position on the touch screen, and adjust the expected video picture of the video to be processed according to the preset view angle.

In some implementations, the first processing unit 901 is configured to adjust the expected video picture of the video to be processed according to a preset view angle, in response to detecting an operation of a view angle icon of a preset view angle displayed on the touch screen, where the preset view angle includes one of a protagonist view angle, a forward view angle, or a panoramic view angle.

In some implementations, the first processing unit 901 is configured to obtain parameter information saved during shooting of the video to be processed or after shooting of the video to be processed, where the parameter information includes path information and/or view angle information, and the parameter information is configured to implement the operation of the preset view angle. The display unit 903 is configured to display one or more view angle icons of the protagonist view angle, forward view angle, or panoramic view angle on the touch screen according to the parameter information, where the protagonist view angle is a view angle of one or more objects in a shooting range of an imaging apparatus, or a view angle of one or more objects determined according to the parameter information. The forward view angle is a view angle in a moving direction of the imaging apparatus, and the panoramic view angle is a view angle that rotates 360 degrees along a horizontal direction from a current picture.

In some implementations, the first processing unit 901 is configured to adjust the expected video picture of the video to be processed by rotating the shooting scene of the video to be processed along a horizontal direction according to the panoramic view angle, in response to detecting an operation of the view angle icon of the panoramic view angle; after the rotation ends, the first processing unit 901 is configured to adjust the expected video picture of the video to be processed according to the target view angle, where the target view angle is the selected protagonist view angle or forward view angle before the detection of the operation of the view angle icon of the panoramic view angle, or the target view angle is the view angle selected according to the joystick before the detection of the operation of the view angle icon of the panoramic view angle.

In some implementations, the first processing unit 901 is configured to generate the target video according to the expected video picture and the set duration if the set duration of the target video is less than or equal to the actual duration of rotating 360 degrees along a horizontal direction, where the target video includes a video picture corresponding to the expected field of view within the set duration; if the set duration of the target video is greater than the actual duration, the first processing unit 901 is configured to generate the target video according to the expected video picture and the actual duration, where the target video includes a video picture corresponding to the expected field of view within the actual duration and a supplementary picture within a remaining duration.

In some implementations, at least two video frames corresponding to the supplementary picture are obtained according to the same video frame of the video to be processed, and the content of at least two video frames is different.

In some implementations, the first processing unit 901 is configured to adjust the expected video picture of the video to be processed according to a somatosensory change magnitude corresponding to a somatosensory interaction operation, in response to detecting a somatosensory interaction operation.

If the somatosensory change magnitude corresponding to the somatosensory interaction operation is less than a preset threshold, the first processing unit 901 is configured to adjust the expected video picture of the video to be processed according to the movement direction of the joystick, in response to detecting an operation of the joystick.

In some implementations, the first processing unit 901 is configured to adjust the expected video picture of the video to be processed according to a superposition result of a control quantity of the joystick and a control quantity of the somatosensory interaction operation, in response to detecting a somatosensory interaction operation during a process of responding to the detection of the operation of the joystick.

In some implementations, the first processing unit 901 is configured to adjust the expected video picture of the video to be processed according to a superposition result of a lever quantity of the joystick and a view angle direction of the forward view angle, in response to detecting an operation of the forward view angle during a process of responding to the detection of the operation of the joystick.

In some implementations, if a change quantity of the movement of the joystick is greater than a change quantity of a somatosensory change magnitude of the somatosensory interaction operation, the first processing unit 901 is configured to adjust the expected video picture of the video to be processed by changing a view angle in a direction of the movement of the joystick, in response to detecting an operation of the joystick; if the change quantity of the movement of the joystick is less than the change quantity of the somatosensory change magnitude of the somatosensory interaction operation, the first processing unit 901 is configured to adjust the expected video picture of the video to be processed by changing the view angle in a direction of the somatosensory interaction operation, in response to detecting a somatosensory interaction operation; and if the change quantity of the movement of the joystick is equal to the change quantity of the somatosensory change magnitude of the somatosensory interaction operation, the first processing unit 901 is configured to adjust the expected video picture of the video to be processed according to an operation of maintaining the view angle.

In some implementations, the first processing unit 901 is configured to adjust the expected video picture of the video to be processed according to a preset view angle, in response to detecting an operation of a view angle icon of a preset view angle displayed on the touch screen; in response to detecting an operation of the joystick, the first processing unit 901 is configured to interrupt the preset view angle, and adjust the expected video picture of the video to be processed according to the movement direction of the joystick.

In some implementations, the first processing unit 901 is configured to adjust the expected video picture of the video to be processed according to a preset view angle, in response to detecting an operation of a view angle icon of a preset view angle displayed on the touch screen; in response to detecting an operation of the joystick, the first processing unit 901 is configured to adjust the expected video picture of the video to be processed according to the movement direction of the joystick; and if the operation of the joystick is cancelled, the first processing unit 901 is configured to adjust the expected video picture of the video to be processed according to the preset view angle.

In some implementations, the first processing unit 901 is configured to determine at least two key frames of the video to be processed, in response to detecting a key frame selection operation by a user; in response to detecting an operation of the joystick, the first processing unit 901 is configured to adjust a transition manner between the at least two key frames in the video to be processed according to a lever quantity of the joystick and a transition curve between the at least two key frames.

In some implementations, the first processing unit 901 is configured to obtain reference information, where the reference information includes one or more of the following:
video specification information of the video to be processed, processing capability information of an image processing device, playback performance selection information input by a user, or video information of the video to be processed; the first processing unit 901 is configured to determine a video generation mode according to the one or more pieces of information in the reference information; and the first processing unit 901 is configured to process the expected video picture according to the determined video generation mode to generate the target video.

In some implementations, the video generation mode includes one of the following:
when saving in a cache, generating a flat video based on the expected video picture corresponding to a main bitstream of the video to be processed and an operation result of adjusting the expected video picture of the video to be processed;
saving, in a cache, an operation result of adjusting the expected video picture of the video to be processed, and when exporting, generating a flat video based on the expected video picture corresponding to an auxiliary bitstream of the video to be processed and the operation result; and
saving, in a cache, the operation result, and when exporting, generating a flat video based on the expected video picture corresponding to a main bitstream of the video to be processed and the operation result.

In some implementations, the first processing unit 901 is configured to: obtain path information in a first time period, where the path information is related to a control quantity of the joystick in the first time period;
smooth the path information; and
determine the expected video picture according to the path information.

In some implementations, the first processing unit 901 is configured to smooth the path information after generating the target video.

In some implementations, the first processing unit 901 is configured to adjust the path information in view of the zero motion path information, when determining, according to the path information, that the path information is zero motion path information, so that the path information in the first time period represents zero motion.

In some implementations, the first processing unit 901 is configured to: pause the execution of generating the target video, in response to detecting a pause operation input by a user, during the process of generating the target video; if a resume operation input by the user is detected, continue the execution of generating the target video; and cancel the execution of generating the target video, in response to detecting a cancel operation input by the user, during the process of generating the target video.

It should be noted that the description of the same operations and content in this implementation and other implementations can refer to the description in other implementations, and will not be repeated here.

The implementations of the present disclosure provide an imaging apparatus, which can be applied to a video processing method provided in the implementation corresponding to FIG. 1. As shown in FIG. 10, the imaging apparatus 10 includes:
a second processing unit 1001, configured to execute the video processing method of the video processing device 9 when the imaging apparatus is in a video recording state, where the video to be processed is a video collected by the imaging apparatus in the video recording state.

It should be noted that the description of the same operations and content in this implementation and other implementations can refer to the description in other implementations, and will not be repeated here.

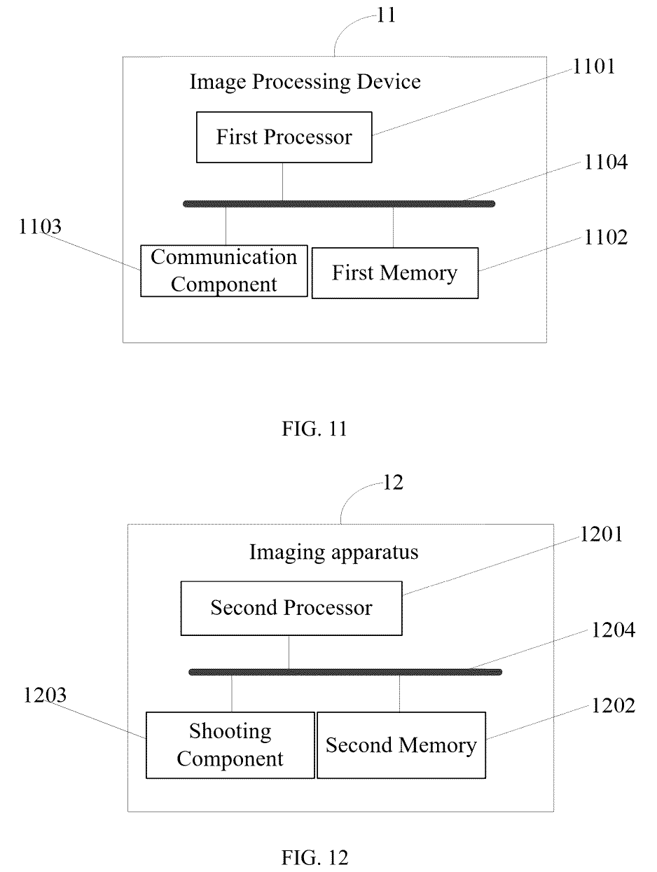

The implementations of the present disclosure provide an image processing device, which can be applied to a video processing method provided in the implementation corresponding to FIG. 1. As shown in FIG. 11, the image processing device 11 (the image processing device 11 in FIG. 11 corresponds to the video processing device 9 in FIG. 9) includes: a first processor 1101, a first memory 1102, a communication component 1103, and a first communication bus 1104, where the first communication bus 1104 is configured to achieve communication connection between the first processor 1101, the first memory 1102, and the communication component 1103.

The communication component is configured to communicate with external devices to obtain the video to be processed; here, the external device can be a camera, and the corresponding communication method is: Wireless Fidelity (Wi-Fi) communication/Bluetooth communication; it can also be a flash transfer companion, and the corresponding communication method is: Universal Serial Bus (USB) communication or other communication methods, such as High Definition Multimedia Interface (HDMI) interface communication;

The first processor 1101 is configured to execute the control program of video processing stored in the first memory 1102 to implement the following operations: adjust the expected video picture of the video to be processed in response to detecting an operation of a joystick; generate a target video according to the expected video picture, where the picture of the target video corresponds to the expected video picture; and save the target video.

In some implementations, the image processing device 11 further includes a display (such as a touch screen) to display the adjusted expected video picture.

In some implementations, the first processor 1101 is configured to execute the control program of video processing stored in the first memory 1102 to implement the following operations: after detecting an operation of the joystick, perform at least one of the following: if a sliding operation on a touch screen is detected, make no response to the sliding operation; and if a somatosensory interaction operation is detected, make no response to the somatosensory interaction operation.

In some implementations, the first processor 1101 is configured to execute the control program of video processing stored in the first memory 1102 to implement the following operations: adjust the expected video picture of the video to be processed by adjusting the speed of angle rotation corresponding to a gear according to a parameter generated based on the movement of the joystick, in response to detecting an operation of a joystick displayed on the touch screen; and there is a one-to-one relationship between the gear and the range to which the parameter belongs.

In some implementations, the first processor 1101 is configured to execute the control program of video processing stored in the first memory 1102 to implement the following operations: adjust the expected video picture of the video to be processed according to the movement direction of the joystick, in response to detecting an operation of a joystick displayed on the touch screen; in response to detecting a trigger operation of a preset view angle, move the joystick to an initial position on the touch screen, and adjust the expected video picture of the video to be processed according to the preset view angle.

In some implementations, the first processor 1101 is configured to execute the control program of video processing stored in the first memory 1102 to implement the following operations: adjust the expected video picture of the video to be processed according to a preset view angle, in response to detecting an operation of a view angle icon of a preset view angle displayed on the touch screen, where the preset view angle includes one of a protagonist view angle, a forward view angle, or a panoramic view angle.

In some implementations, the first processor 1101 is configured to execute the control program of video processing stored in the first memory 1102 to implement the following operations: obtain parameter information saved during shooting of the video to be processed or after shooting of the video to be processed, where the parameter information includes path information and/or view angle information, and the parameter information is configured to implement the operation of the preset view angle; display one or more view angle icons of the protagonist view angle, forward view angle, or panoramic view angle on the touch screen according to the parameter information, where the protagonist view angle is a view angle of one or more objects in a shooting range of an imaging apparatus, or a view angle of one or more objects determined according to the parameter information, where the forward view angle is a view angle in a moving direction of the imaging apparatus, and the panoramic view angle is a view angle that rotates 360 degrees along a horizontal direction from a current picture.

In some implementations, the first processor 1101 is configured to execute the control program of video processing stored in the first memory 1102 to implement the following operations: adjust the expected video picture of the video to be processed by rotating the shooting scene of the video to be processed along a horizontal direction according to the panoramic view angle, in response to detecting an operation of the view angle icon of the panoramic view angle; and after the rotation ends, adjust the expected video picture of the video to be processed according to the target view angle,

where the target view angle is the selected protagonist view angle or forward view angle before the detection of the operation of the view angle icon of the panoramic view angle, or the target view angle is the view angle selected according to the joystick before the detection of the operation of the view angle icon of the panoramic view angle.

In some implementations, the first processor 1101 is configured to execute the control program of video processing stored in the first memory 1102 to implement the following operations: generate the target video according to the expected video picture and the set duration if the set duration of the target video is less than or equal to the actual duration of rotating 360 degrees along a horizontal direction, where the target video includes a video picture corresponding to the expected field of view within the set duration; and if the set duration of the target video is greater than the actual duration, generate the target video according to the expected video picture and the actual duration, where the target video includes a video picture corresponding to the expected field of view within the actual duration and a supplementary picture within a remaining duration.

In some implementations, the first processor 1101 is configured to execute the control program of video processing stored in the first memory 1102 to implement the following operations: at least two video frames corresponding to the supplementary picture are obtained according to the same video frame of the video to be processed, and the content of at least two video frames is different.

In some implementations, the first processor 1101 is configured to execute the control program of video processing stored in the first memory 1102 to implement the following operations: adjust the expected video picture of the video to be processed according to a somatosensory change magnitude corresponding to a somatosensory interaction operation, in response to detecting a somatosensory interaction operation; and
if the somatosensory change magnitude corresponding to the somatosensory interaction operation is less than a preset threshold, adjust the expected video picture of the video to be processed according to the movement direction of the joystick, in response to detecting an operation of the joystick.

In some implementations, the first processor 1101 is configured to execute the control program of video processing stored in the first memory 1102 to implement the following operations: detect a somatosensory interaction operation during a process of responding to the detection of the operation of the joystick; and adjust the expected video picture of the video to be processed according to a superposition result of a control quantity of the joystick and a control quantity of the somatosensory interaction operation.

In some implementations, the first processor 1101 is configured to execute the control program of video processing stored in the first memory 1102 to implement the following operations: detect an operation of the joystick during a process of responding to the detection of the operation of the forward view angle; and adjust the expected video picture of the video to be processed according to a superposition result of a lever quantity of the joystick and a view angle direction of the forward view angle.

In some implementations, the first processor 1101 is configured to execute the control program of video processing stored in the first memory 1102 to implement the following operations: detect a somatosensory interaction operation during a process of responding to the detection of the operation of the joystick; adjust the expected video picture of the video to be processed by changing a view angle in a direction of the movement of the joystick, in response to detecting an operation of the joystick, if a change quantity of the movement of the joystick is greater than a change quantity of a somatosensory change magnitude of the somatosensory interaction operation; if the change quantity of the movement of the joystick is less than the change quantity of the somatosensory change magnitude of the somatosensory interaction operation, adjust the expected video picture of the video to be processed by changing the view angle in a direction of the somatosensory interaction operation, in response to detecting a somatosensory interaction operation; and if the change quantity of the movement of the joystick is equal to the change quantity of the somatosensory change magnitude of the somatosensory interaction operation, adjust the expected video picture of the video to be processed according to an operation of maintaining the view angle.

In some implementations, the first processor 1101 is configured to execute the control program of video processing stored in the first memory 1102 to implement the following operations: adjust the expected video picture of the video to be processed according to a preset view angle, in response to detecting an operation of a view angle icon of a preset view angle displayed on the touch screen; and in response to detecting an operation of the joystick, interrupt the preset view angle, and adjust the expected video picture of the video to be processed according to the movement direction of the joystick.

In some implementations, the first processor 1101 is configured to execute the control program of video processing stored in the first memory 1102 to implement the following operations: adjust the expected video picture of the video to be processed according to a preset view angle, in response to detecting an operation of a view angle icon of a preset view angle displayed on the touch screen; in response to detecting an operation of the joystick, adjust the expected video picture of the video to be processed according to the movement direction of the joystick; and if the operation of the joystick is cancelled, adjust the expected video picture of the video to be processed according to the preset view angle.

In some implementations, the first processor 1101 is configured to execute the control program of video processing stored in the first memory 1102 to implement the following operations: determine at least two key frames of the video to be processed, in response to detecting a key frame selection operation by a user; in response to detecting an operation of the joystick, adjust a transition manner between the at least two key frames in the video to be processed according to a lever quantity of the joystick and a transition curve between the at least two key frames.

In some implementations, the first processor 1101 is configured to execute the control program of video processing stored in the first memory 1102 to implement the following operations: obtain reference information, where the reference information includes one or more of the following: video specification information of the video to be processed, processing capability information of an image processing device, playback performance selection information input by a user, and video information of the video to be processed; determine a video generation mode according to the one or more pieces of information in the reference information; and process the expected video picture according to the determined video generation mode to generate the target video.

In some implementations, the video generation mode includes one of the following: when saving in a cache, generating a flat video based on the expected video picture corresponding to a main bitstream of the video to be processed and an operation result of adjusting the expected video picture of the video to be processed; saving, in a cache, an operation result of adjusting the expected video picture of the video to be processed, and when exporting, generating a flat video based on the expected video picture corresponding to an auxiliary bitstream of the video to be processed and the operation result; and saving, in a cache, the operation result, and when exporting, generating a flat video based on the expected video picture corresponding to a main bitstream of the video to be processed and the operation result.

In some implementations, the first processor 1101 is configured to execute the control program of video processing stored in the first memory 1102 to implement the following operations: obtain path information in a first time period, where the path information is related to a control quantity of the joystick in the first time period; and smooth the path information; determine the expected video picture according to the path information.

In some implementations, the first processor 1101 is configured to execute the control program of video processing stored in the first memory 1102 to implement the following operations: smooth the path information after generating the target video.

In some implementations, the first processor 1101 is configured to execute the control program of video processing stored in the first memory 1102 to implement the following operations: adjust the path information in view of the zero motion path information, when determining, according to the path information, that the path information is zero motion path information, so that the path information in the first time period represents zero motion.

In some implementations, the first processor 1101 is configured to execute the control program of video processing stored in the first memory 1102 to implement the following operations: pause the execution of generating the target video, in response to detecting a pause operation input by a user, during the process of generating the target video; if a resume operation input by the user is detected, continue the execution ofgenerating the target video; and cancel the execution of generating the target video, in response to detecting a cancel operation input by the user, during the process of generating the target video.

It should be noted that the specific implementation process of the operations executed by the first processor in this implementation can refer to the implementation process of the video processing method provided in the implementation corresponding to FIG. 1, and will not be repeated here.

The implementations of the present disclosure provide an imaging apparatus, in some implementations, the imaging apparatus can be a sports camera, drone, Digital Single-Lens Reflex (DSLR) camera, mobile phone, or other devices.

The imaging apparatus can be applied to a video processing method provided in the implementation corresponding to FIG. 1. As shown in FIG. 12, the imaging apparatus 12 (the imaging apparatus 12 in FIG. 12 corresponds to the imaging apparatus 10 in FIG. 10) includes: a second processor 1201, a second memory 1202, a shooting component 1203, and a second communication bus 1204, where:
the second communication bus 1204 is configured to achieve a communication connection between the second processor 1201, the second memory 1202, and the shooting component 1203;
the shooting component 1203 is used for shooting videos; here, the shooting component can be a panoramic camera; and
the second processor 1201 is used to execute the control program of video processing stored in the second memory 1202 to implement the above operations.

It should be noted that the specific implementation process of the operations executed by the second processor in this implementation can refer to the implementation process of the video processing method provided in the implementation corresponding to FIG. 1, and will not be repeated here.

It can be understood that the devices and apparatuses depicted in FIGS. 9-12 may be implemented either collectively as an integrated system or separately as independent components, depending on the specific design and application requirements. For instance, in certain implementations, the image processing device 11, which operates in accordance with the method illustrated in FIG. 1, can be integrated with the imaging apparatus 12, which also employs the same method. This integration can enhance system efficiency, streamline data processing, and reduce latency by minimizing the need for external communication between separate devices. Alternatively, in cases where modularity and flexibility are prioritized, the devices may be deployed separately to allow for independent upgrades, maintenance, or adaptation to different operational environments.

As an example, the processor can be an integrated circuit chip with signal processing capability, such as a general-purpose processor, digital signal processor (DSP), or other programmable logic devices, discrete gate or transistor logic devices, discrete hardware components, etc., where the general-purpose processor can be a microprocessor or any conventional processor, etc.

It should be noted that the specific implementation process of the operations executed by the processor in this implementation can refer to the implementation process of the video processing method provided in the implementation corresponding to FIG. 1, and will not be repeated here.

The implementations of the present disclosure provide a computer-readable storage medium, which stores one or more programs that can be executed by one or more processors to implement the implementation process of the video processing method provided in the implementation corresponding to FIG. 1, and will not be repeated here.

The implementations of the present disclosure provide a computer product, including a computer program, which can be executed by one or more processors to implement the implementation process of the video processing method provided in the implementation corresponding to FIG. 1, and will not be repeated here.

The above-mentioned computer storage medium/memory can be Read Only Memory (ROM), Programmable Read-Only Memory (PROM), Erasable Programmable Read-Only Memory (EPROM), Electrically Erasable Programmable Read-Only Memory (EEPROM), Ferromagnetic Random Access Memory (FRAM), Flash Memory, magnetic surface memory, optical disk, or Compact Disc Read-Only Memory (CD-ROM), etc.; it can also be various terminals including one or any combination of the above memories, such as mobile phones, computers, tablet devices, personal digital assistants, etc.

It should be understood that “an implementation” or “one implementation” or “the implementation of the present disclosure” or “the aforementioned implementation” or “some implementations” or “some implementations” mentioned throughout the specification means that a specific feature, structure, or characteristic related to the implementation is included in at least one implementation of the present disclosure. Therefore, the appearances of “in one implementation” or “in an implementation” or “the implementation of the present disclosure” or “the aforementioned implementation” or “some implementations” or “some implementations” in various places throughout the specification do not necessarily refer to the same implementation. Furthermore, these specific features, structures, or characteristics can be combined in any suitable manner in one or more implementations. It should be understood that in various implementations of the present disclosure, the size of the serial numbers of the above processes does not imply the order of execution, and the execution order of each process should be determined by its function and internal logic, and should not constitute any limitation on the implementation process of the implementations of the present disclosure. The serial numbers of the implementations of the present disclosure are only for description and do not represent the advantages or disadvantages of the implementations.

In several implementations provided by the present disclosure, it should be understood that the disclosed devices and methods can be implemented in other ways. The device implementations described above are merely illustrative, for example, the division of units is merely a logical function division, and in actual implementation, there can be other division methods, such as: multiple units or components can be combined, or integrated into another system, or some features can be ignored or not executed. In addition, the coupling or direct coupling or communication connection between the various components shown or discussed can be through some interfaces, indirect coupling or communication connection of devices or units, which can be electrical, mechanical, or other forms.

The units described as separate components above can be, or may not be, physically separate, and the components displayed as units can be, or may not be, physical units; they can be located in one place or distributed across multiple network units; some or all of the units can be selected to achieve the purpose of the implementation scheme of this implementation based on actual needs.

In addition, the functional units in each implementation of the present disclosure can be all integrated into one processing unit, or each unit can be separately as an individual unit, or two or more units can be integrated into one unit; the integrated unit can be implemented in the form of hardware, or in the form of hardware plus software functional units.

The methods disclosed in several method implementations provided by the present disclosure can be combined arbitrarily to obtain new method implementations, as long as there is no conflict.

The features disclosed in several product implementations provided by the present disclosure can be combined arbitrarily to obtain new product implementations, as long as there is no conflict.

The features disclosed in several method or device implementations provided by the present disclosure can be combined arbitrarily to obtain new method implementations or device implementations, as long as there is no conflict.

Those skilled in the art can understand that all or part of the operations of the above method implementations can be completed by program instructions related to hardware, and the aforementioned program can be stored in a computer-readable storage medium, and the program can execute the operations of the above method implementations when executed; and the aforementioned storage medium includes: mobile storage devices, Read Only Memory (ROM), magnetic disks, or optical disks, etc., which can store program codes.

Alternatively, if the integrated units of the present disclosure are implemented in the form of software functional modules and sold or used as independent products, they can also be stored in a computer-readable storage medium. Based on such understanding, the technical solutions of the implementations of the present disclosure can essentially be embodied in the form of a software product, and the computer software product is stored in a storage medium, including several instructions to enable a computer device (which can be a personal computer, server, or network device, etc.) to execute all or part of the methods described in each implementation of the present disclosure. The aforementioned storage medium includes: mobile storage devices, ROM, magnetic disks, or optical disks, etc., which can store program codes.

It is worth noting that the drawings in the implementations of the present disclosure are only for illustrating the schematic positions of each device on the terminal device and do not represent the actual positions in the terminal device. The actual positions of each device or each area can be changed or shifted according to actual conditions (for example, the structure of the terminal device), and the proportions of different parts in the terminal device in the drawings do not represent the actual proportions.

The above description is only an implementation of the present disclosure, but the protection scope of the present disclosure is not limited to this. Any changes or substitutions that can be easily thought of by those skilled in the art within the technical scope disclosed in the present disclosure should be covered within the protection scope of the present disclosure. Therefore, the protection scope of the present disclosure should be subject to the protection scope of the claims.

What is claimed is:

1. A video processing method, comprising:
in response to detecting an operation of a joystick, adjusting an expected video picture of a video to be processed;
generating a target video according to the expected video picture, wherein a picture of the target video corresponds to the expected video picture; and
saving the target video.

2. The video processing method according to claim 1, further comprising:
displaying the expected video picture after adjustment.

3. The video processing method according to claim 1, wherein after the response to detecting the operation of the joystick, the method further comprises at least one of:
when a sliding operation on a touch screen is detected, making no response to the sliding operation; or
when a somatosensory interaction operation is detected, making no response to the somatosensory interaction operation.

4. The video processing method according to claim 1, wherein adjusting, in response to detecting the operation of the joystick, the expected video picture of the video to be processed comprises:
in response to detecting the operation of the joystick displayed on a touch screen, adjusting a speed of angle rotation corresponding to a gear according to a parameter generated based on movement of the joystick, to adjust the expected video picture of the video to be processed, wherein there is a one-to-one relationship between the gear and a range to which the parameter belongs.

5. The video processing method according to claim 1, wherein adjusting, in response to detecting the operation of the joystick, the expected video picture of the video to be processed comprises:
in response to detecting the operation of the joystick displayed on a touch screen, adjusting the expected video picture of the video to be processed according to a movement direction of the joystick; and
in response to detecting a trigger operation of a preset view angle, moving the joystick on the touch screen to an initial position, and adjusting the expected video picture of the video to be processed according to the preset view angle.

6. The video processing method according to claim 1, further comprising:
in response to detecting an operation of a view angle icon of a preset view angle displayed on a touch screen, adjusting the expected video picture of the video to be processed according to the preset view angle, wherein the preset view angle comprises one of a protagonist view angle, a forward view angle, or a panoramic view angle.

7. The video processing method according to claim 1, wherein generating the target video according to the expected video picture comprises:
when a set duration of the target video is less than or equal to an actual duration of rotating 360 degrees along a horizontal direction, generating the target video according to the expected video picture and the set duration, wherein the target video comprises a video picture corresponding to the expected field of view within the set duration; and
when the set duration of the target video is greater than the actual duration, generating the target video according to the expected video picture and the actual duration, wherein the target video comprises a video picture corresponding to the expected field of view within the actual duration and a supplementary picture within a remaining duration.

8. The video processing method according to claim 1, wherein adjusting, in response to detecting the operation of the joystick, the expected video picture of the video to be processed comprises:
in response to detecting a somatosensory interaction operation, adjusting the expected video picture of the video to be processed according to a somatosensory change magnitude corresponding to the somatosensory interaction operation; and
when the somatosensory change magnitude corresponding to the somatosensory interaction operation is less than a preset threshold, adjusting the expected video picture of the video to be processed according to a movement direction of the joystick in response to detecting the operation of the joystick.

9. The video processing method according to claim 1, wherein adjusting, in response to detecting the operation of the joystick, the expected video picture of the video to be processed comprises:
detecting a somatosensory interaction operation during a process of responding to the detection of the operation of the joystick; and
adjusting the expected video picture of the video to be processed according to a superposition result of a control quantity of the joystick and a control quantity of the somatosensory interaction operation.

10. The video processing method according to claim 1, wherein:
during a process of responding to detecting an operation of a forward view angle of a preset view angle, the operation of the joystick is detected; and
the expected video picture of the video to be processed is adjusted according to a superposition result of a lever quantity of the joystick and a view angle direction of the forward view angle.

11. The video processing method according to claim 1, wherein adjusting, in response to detecting the operation of the joystick, the expected video picture of the video to be processed comprises:
detecting a somatosensory interaction operation during a process of responding to the detection of the operation of the joystick;
when a change quantity of a movement of the joystick is greater than a change quantity of a somatosensory change magnitude of the somatosensory interaction operation, in response to the detection of the operation of the joystick, adjusting the expected video picture of the video to be processed by changing a view angle in a direction of the movement of the joystick;
when the change quantity of the movement of the joystick is less than the change quantity of the somatosensory change magnitude of the somatosensory interaction operation, in response to detecting a somatosensory interaction operation, adjusting the expected video picture of the video to be processed by changing the view angle in a direction of the somatosensory interaction operation; and
when the change quantity of the movement of the joystick is equal to the change quantity of the somatosensory change magnitude of the somatosensory interaction operation, adjusting the expected video picture of the video to be processed according to an operation of maintaining the view angle.

12. The video processing method according to claim 1, wherein adjusting, in response to detecting the operation of the joystick, the expected video picture of the video to be processed comprises:
in response to detecting an operation of a view angle icon of a preset view angle displayed on a touch screen, adjusting the expected video picture of the video to be processed according to the preset view angle; and
in response to detecting the operation of the joystick, interrupting the preset view angle, and adjusting the expected video picture of the video to be processed according to a movement direction of the joystick.

13. The video processing method according to claim 1, wherein adjusting, in response to detecting the operation of the joystick, the expected video picture of the video to be processed comprises:
in response to detecting an operation of a view angle icon of a preset view angle displayed on a touch screen, adjusting the expected video picture of the video to be processed according to the preset view angle;
in response to detecting the operation of the joystick, adjusting the expected video picture of the video to be processed according to a movement direction of the joystick; and
when the operation of the joystick is cancelled, adjusting the expected video picture of the video to be processed according to the preset view angle.

14. The video processing method according to claim 1, further comprising:
in response to detecting a key frame selection operation by a user, determining at least two key frames of the video to be processed; and
in response to detecting the operation of the joystick, adjusting a transition manner between the at least two key frames in the video to be processed according to a lever quantity of the joystick and a transition curve between the at least two key frames.

15. The video processing method according to claim 1, wherein generating the target video according to the expected video picture comprises:
obtaining reference information, wherein the reference information comprises at least one piece of information of: video specification information of the video to be processed, processing capability information of an image processing device, playback performance selection information input by a user, or video information of the video to be processed;
determining a video generation mode according to the at least one piece of information in the reference information; and
processing the expected video picture according to the determined video generation mode to generate the target video.

16. The video processing method according to claim 1, further comprising:
obtaining path information in a first time period, wherein the path information is related to a control quantity of the joystick in the first time period;
smoothing the path information; and
determining the expected video picture according to the path information.

17. The video processing method according to claim 1, further comprising:
in a process of generating the target video, pausing the execution of generating the target video in response to detecting a pause operation input by a user;
in response to detecting a resume operation input by the user, resuming the execution of generating the target video; and
in a process of generating the target video, cancelling the execution of generating the target video in response to detecting a cancel operation input by the user.

18. An apparatus, comprising an imaging processing device that comprises a communication component, a first processor, and a first memory,
wherein:
the communication component is configured to be connected to an external apparatus for communicating to obtain a first video to be processed;
the first memory is configured to store a first computer program that is executed on the first processor; and
the first processor is configured to, when executing the first computer program, perform:
in response to detecting a first operation of a joystick, adjusting a first expected video picture of the first video to be processed;
generating a first target video according to the first expected video picture, wherein a first picture of the first target video corresponds to the first expected video picture; and
saving the first target video.

19. The apparatus of claim 18, further comprising an imaging apparatus that comprises a shooting component, a second processor, and a second memory,
wherein:
the shooting component is configured to shoot a second video;
the second memory is configured to store a second computer program that is executed on the second processor; and
wherein the second processor is configured to, when executing the second computer program, perform:
in response to detecting a second operation of the joystick, adjusting a second expected video picture of the second video to be processed;
generating a second target video according to the second expected video picture, wherein a second picture of the second target video corresponds to the second expected video picture; and
saving the second target video.

20. A storage medium, wherein a computer program is stored on the storage medium, and when the computer program is executed by a processor, the processor is configured to perform:
in response to detecting an operation of a joystick, adjusting an expected video picture of a video to be processed;
generating a target video according to the expected video picture, wherein a picture of the target video corresponds to the expected video picture; and
saving the target video.
